(19) United States
(12) Patent Application Publication
(10) Pub. No.: US 2024/0103988 A1
(43) Pub. Date: Mar. 28, 2024

(54) Computer-Implemented Method And Control Device For Controlling A Unit Of An Automotive System

(71) Applicant: Vitesco Technologies GmbH, Regensburg (DE)

(72) Inventors: Johannes Lex, Pentling (DE); Ralph Mader, Bad Abbach (DE)

(73) Assignee: Vitesco Technologies GmbH, Regensburg (DE)

(21) Appl. No.: 18/529,328

(22) Filed: Dec. 5, 2023

Related U.S. Application Data
(63) Continuation of application No. PCT/EP2022/065084, filed on Jun. 2, 2022.

(30) Foreign Application Priority Data
Jun. 25, 2021 (DE) 10 2021 206 637.2
Sep. 13, 2021 (DE) 10 2021 210 077.5

(51) Int. Cl. G06F 11/20

(52) U.S. Cl. CPC G06F 11/2028; G06F 11/2033; B60W 50/023; G06F 2201/85

(57) ABSTRACT

The disclosure relates to a computer-implemented method and a control device for controlling a unit of an automotive system. An electrical/electronic architecture of the automotive system includes a first control unit, a second control unit, and the unit to be controlled. The method includes detecting that the control of the unit by a primary software cluster is faulty and/or defective. The method also includes activating the second control unit by the first control unit, whereby the second control unit is transferred to a fail-silent state and does not send any more potentially erroneous data. Additionally, the method includes controlling the unit by a backup software cluster of the first control unit, thereby maintaining the functionality of the unit.

### CROSS-REFERENCE TO RELATED APPLICATIONS

This application claims the benefit of PCT Application PCT/EP2022/065084, filed Jun. 2, 2019, which claims priority to German Application 10 2021 206 637.2, filed Jun. 25, 2021 and German Application 10 2021 210 077.5, filed Sep. 13, 2021. The disclosures of the above applications are incorporated herein by reference.

### TECHNICAL FIELD

The disclosure relates to a computer-implemented method and a control device for controlling a unit of an automotive system. The electrical/electronic architecture of the automotive system includes a first control unit, a second control unit, and the unit to be controlled. For example, the first control unit and the second control unit are electrical control units. For controlling the unit, which is, for example an actuator or a sensor, a software cluster implemented in one of the control units is used.

### BACKGROUND

Current developments in the automotive industry, such as extensive driver assistance systems, are giving rise to exponential growth in the range of software in electronic control units. AUTOSAR Classic describes a standardized software architecture for such electronic control units. In conventional software architectures, the entire software of an electrical control unit must be created as a complete and closed element, which, in addition to long build times, also results in all software components being strongly dependent on one another. With the introduction of the AR Flex concept, AUTOSAR Classic now offers a way of dividing the overall software into individual subcomponents. The application level of an ECU software is divided into software clusters (SWCL) that are as independent as possible. All software clusters are separate components that can be built and loaded separately from one another. In addition to the software architecture, the electrical/electronic architecture of an automotive system is undergoing profound change. In order to meet the increasing demand for computing power in an automotive system without increasing the complexity of the E/E architecture, this is becoming increasingly centralized. Multiple domain-specific control units are combined to form a few high-performance vehicle servers and master controllers. The focus of the vehicle servers is on high computing power. The master controllers, on the other hand, are used, for example, for control tasks. The two different architectures of vehicle servers and master controllers also affect the software architecture that can be used. The AUTOSAR Adaptive Architecture has been designed for optimal use of the resources of a vehicle server. This enables AUTOSAR-compliant software development on a POSIX-based operating system.

In conventional automotive systems, for example, a unit such as an actuator or a sensor is controlled by a specific control unit designed for the purpose, which in turn executes the appropriate software. In order to create redundancy in safety-critical units of the automotive system, for example, multiple side-by-side hardware components are conventionally installed, which can each control the corresponding unit and thus replace the failed control unit in the event of a fault in a control unit.

### SUMMARY

The disclosure provides a method and a device for enabling an advantageously simple and reliable control of a unit of an automotive system.

One aspect of the disclosure provides a computer-implemented method for controlling a unit of an automotive system comprises the steps listed below. An electrical/electronic architecture of the automotive system includes a first control unit, a second control unit and the unit to be controlled. The second control unit is designed to control the unit by a primary software cluster. In other words, the primary software cluster is executed on the second control unit, which controls the unit to be controlled of the automotive system.

In some implementations, the first control unit is designed to assume the control of the unit by a backup software cluster in the event of a fault of the second control unit. In other words, the backup software cluster executed on the first control unit can also be used to assume control of the unit. The method steps include detecting that the control of the unit by way of the primary software cluster is faulty and/or defective. In accordance with this method step, e.g., during the operation of the automotive system, it is detected that the control of the unit by the primary software cluster on the second control unit is faulty and/or defective. As a result, the control of the unit by the second control unit is not functioning properly. The method steps also include activating the second control unit by the first control unit, where the second control unit is transferred to a fail-silent state and does not send any more potentially erroneous data. According to this method step, after it has been detected that the control of the unit by the primary software cluster is faulty and/or defective, the faulty second control unit is transferred into the fail-silent state by activation via the first control unit, which means that erroneous control data is no longer sent to the unit to be controlled of the automotive system and/or incorrect data is no longer sent to other components of the automotive system. The fail-silent state is therefore used to prevent potential error propagation within the automotive system and at the same time to transfer the faulty second control unit into a standby state. In some examples, the fail-silent state is initiated by switching off the corresponding receivers (e.g. ETH transceivers). The method steps also include controlling the unit by the backup software cluster of the first control unit, thereby maintaining the functionality of the unit. According to this method step, the control of the unit to be controlled of the automotive system is then ensured by the first control unit, such as by the backup software cluster, which is executed on the first control unit for controlling the unit. Accordingly, the backup software cluster can be used to maintain the functionality of the unit to be controlled.

Implementations of the disclosure may include one or more of the following optional features. In some implementations, the control of the unit by the backup software cluster of the first control unit can therefore be ensured, even if the control of the unit by the primary software cluster of the second control unit is faulty and/or defective. Accordingly, a redundancy can be built within the automotive system for controlling the unit without the need to install additional hardware components, but solely by an arrangement of a backup software cluster in a further already existing control unit within the automotive system. According to the disclosure, an advantageous simple and redundant control of the unit of the automotive system can therefore be implemented, e.g., using the AR Flex concept of AUTOSAR Classic. Redundancy can be achieved even if the first control unit and the second control unit are based on different hardware and software architectures.

In some implementations, the electrical/electronic architecture of the automotive system also includes a third control unit, which is designed to receive control commands for controlling the unit from the first control unit or the second control unit and where the control of the unit is carried out via the third control unit. In some examples, the third control unit can be implemented as a virtual application in the first or second control unit. In some examples, the third control unit can be installed as a physical additional control unit. The third control unit can receive control commands, for example, from the first or the second control unit to translate them into a language executable for the unit to be controlled, and accordingly to activate the unit to be controlled. The third control unit in this respect can be regarded as an intermediary between the first or the second control unit and the unit to be controlled. A plurality of different units to be controlled can accordingly be activated by the third control unit.

In some implementations, the first control unit is a master controller, the second control unit is a vehicle server, and the third control unit is a zone control unit. The vehicle server has an advantageously high computing power according to one example. The master controller may be designed, to assume control tasks within the automotive system and the zone control unit is designed to assume specific control tasks of a few predefined units, such as actuators and/or sensors, for a specially predefined zone within the automotive system.

In some implementations, the first control unit includes a microcontroller and the second control unit includes a microprocessor. The first control unit is provided, for example, as a master controller such as, for control tasks and has a microcontroller, so that the master controller can perform the necessary properties for the execution of control tasks. The second control unit is configured, in some examples, as a vehicle server and has a microprocessor which has the necessary properties to assume the tasks of the vehicle server. The microcontroller has compatibility advantages because conventional automotive software has been designed for microcontroller-based ECUs. In addition, microcontrollers are less expensive. In addition, software designed for a microcontroller may have higher real-time requirements. Microprocessors have higher computing power and can run POSIX-based operating systems, the use of which increases software compatibility with other systems.

In some examples, during operation, the second control unit sends a heartbeat signal to the first control unit continuously or cyclically, where the first control unit detects that the control of the unit by the second control unit is faulty or defective if the heartbeat signal is absent or faulty. In other words, the second control unit sends the heartbeat signal continuously or cyclically to the first control unit to communicate its full functionality to the first control unit. As soon as an error or defect occurs within the second control unit, the heartbeat signal is interrupted, which means that the heartbeat signal does not reach the first control unit. Accordingly, the first control unit can detect that the second control unit is faulty and/or defective, which can initiate further steps for controlling the unit to be controlled of the automotive system. By way of the heartbeat signal, it is therefore advantageously easy to detect whether the second control unit, which in normal operation assumes the control of the unit to be controlled of the automotive system, is functioning properly. In some examples, the heartbeat signal is sent from the second control unit every millisecond or every ten milliseconds. A number of milliseconds between one and ten milliseconds is also conceivable.

In some implementations, the third control unit is activated by the first control unit to filter out and not to forward any data packets received from the second control unit, as soon as it is detected that the control of the unit by the second control unit is faulty or defective. If, for example, the heartbeat signal of the second control unit is absent, the third control unit is accordingly activated by the first control unit in such a way that all data packets sent from the second control unit to the third control unit are filtered out or not forwarded. Accordingly, it is ensured that any erroneous data packets from the second control unit are not used to control the unit to be controlled of the automotive system, but that the control is assumed by way of the backup software cluster on the first control unit, which therefore ensures that a functioning software cluster can assume control of the unit to be controlled and it is not controlled by erroneous data from the second control unit.

In some implementations, the control of the unit via the first control unit is carried out by the backup software cluster. The backup software cluster according to the AR Flex concept in AUTOSAR Classic is the redundant software cluster to the primary software cluster, which is used on the second control unit during normal operation of the second control unit to control the unit. However, if the primary software cluster is faulty or the second control unit is defective or faulty, the unit is controlled via the first control unit by the backup software cluster. In some examples, data which is required for the control of the unit, and which is transmitted to the second control unit in normal operation, is transmitted to the first control unit so that the backup software cluster can perform a proper control of the unit of the automotive system. In some examples, a synchronization between the primary software cluster and the backup software cluster is performed so that an advantageous control of the unit to be controlled can be implemented.

In some implementations, the unit to be controlled is connected to the first control unit by a Service Discovery process, as soon as it is detected that the control of the unit by the second control unit is faulty or defective. In some examples, the third control unit is connected to the first control unit by a Service Discovery, as soon as it is detected that the control of the unit by the second control unit is faulty or defective. The Service Discovery refers to the automatic detection of services in a computer network. The “Scalable Service Oriented MiddlewarE over IP (SOME/IP)” enables service-oriented transmission of information. The Service Discovery Protocol communicates the availability of functional entities, called services, in the automotive system. The service cyclically sends “Service Offer” messages to the entire network (broadcast). One or more clients receive this service offer and check if they want to connect to this service. If yes, the client sends a subscribe message to the sender (unicast), which in turn responds with an Acknowledge. The client then waits for events from the server. Service Discovery is advantageously widely used and standardized and is available in both AUTOSAR Classic and AUTOSAR Adaptive.

In some implementations, the activation of the second control unit by the first control unit to transfer the second control unit into the fail-silent state is carried out by a packet filter. According to this example, all input and output data of the second control unit are accordingly filtered out, so that the faulty second control unit within the automotive system does not give rise to error propagation and to erroneous data transmission. According to this example, no data packets with the second control unit (vehicle server) as sender or receiver are forwarded or processed. Accordingly, the (defective) second control unit is in a defined and safe state and the fault(s) in the second control unit do(es) not affect the rest of the system.

In some implementations, the unit to be controlled is an actuator, a sensor to be monitored or another unit to be controlled of an automotive system, or a combination of these. The unit to be controlled is, for example, an electrical machine, a generator, a pressure sensor, a temperature sensor, a drivetrain or part of a drivetrain or any other unit to be controlled of the automotive system.

In some implementations, the automotive system additionally includes a monitoring unit which is designed to monitor whether the unit to be controlled is properly controlled by the backup software cluster of the first control unit. According to this example, the monitoring unit is accordingly used to monitor whether the control of the unit to be controlled by the backup software cluster is functioning properly in the event of a fault of the second control unit. The monitoring unit can be implemented according to one implementation within the first control unit, for example, and according to another implementation the monitoring unit may be installed in the automotive system as a separate control unit, or according to a further implementation the monitoring unit may also be embodied as only a further software cluster, which is designed explicitly for monitoring, within the first control unit.

Another aspect of the disclosure provides a control device for controlling a unit of an automotive system, where an electrical/electronic architecture of the automotive system includes a first control unit, a second control unit, and the unit to be controlled. The second control unit is designed to control the unit by a primary software cluster and the first control unit is designed to assume control of the unit by a backup software cluster in the event of a fault of the second control unit. The control device is designed to carry out one of the above-mentioned methods. The control device according to this aspect can consist of and/or include the first control unit, the second control unit, and the third control unit and/or include additional control units. The control device according to this aspect may be installed according to a further example as part of an additional control unit within the automotive system.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic illustration of an E-E architecture of an automotive system according to a first example.

FIG. 2 shows a schematic illustration of an E-E architecture of an automotive system according to a second example.

FIG. 3 shows a schematic illustration of an E-E architecture of an automotive system according to a third example.

FIG. 4 shows a schematic illustration of an E-E architecture of an automotive system according to a fourth example.

FIG. 5 shows a schematic illustration of a method sequence for controlling a unit according to a first example.

Like reference symbols in the various drawings indicate like elements.

### DETAILED DESCRIPTION

FIG. 1 shows an E-E/hardware architecture of an automotive system 100. The automotive system 100 has a first vehicle server 110 and a second vehicle server 120. The first vehicle server 110 and the second vehicle server 120 can communicate with each other. This is shown schematically with the dashed line between the first vehicle server 110 and the second vehicle server 120. The automotive system 100, as shown in FIG. 1, additionally includes a first master controller 130 and a second master controller 140. The master controllers 130, 140 can communicate with each other and additionally with one of the vehicle servers 110, 120. As shown, the first master controller 130 can communicate with the first vehicle server 110, and according to this example the second master controller 140 can communicate with the second vehicle server 120. The first master controller 130 is additionally assigned a first sensor 132 and an actuator 134. The first master controller 130 is designed to control the first sensor 132 or process its sensor data. In addition, the first master controller 130 is designed to control the first actuator 134. The second master controller 140 is assigned an electrical control unit 142, a second sensor 144 and a second actuator 146. The second master controller 140 is designed to control the first electrical control unit or to receive and further process its data. In addition, the second master controller 140 is designed to receive and further process sensor data of the second sensor 144 and to control the second sensor 144 if necessary. In addition, the second master controller 140 is designed to control the second actuator 146. The automotive system 100 additionally includes a first zone control unit 150, a second zone control unit 160, and an eighth zone control unit 170. As FIG. 1 schematically shows, additional zone control units may be installed. The first zone control unit 150, the second zone control unit 160, and the additional zone control units up to the eighth zone control unit 170 can communicate with one another.

As shown in FIG. 1, the first zone control unit 150 is connected to the first vehicle server 110 and the first master controller 130. In addition, it is schematically illustrated that the further zone control units can also be or are connected to the first master controller 130 and the first vehicle server 110 and the second vehicle server 120. According to this example, a third actuator 152 is assigned to the first zone control unit 150. The first zone control unit 150 is accordingly designed to control the third actuator 152. The second zone control unit 160 is assigned a third sensor 162 and a second electrical control unit 164. The second zone control unit 160 is accordingly designed, for example, to receive and forward the sensor data of the third-party sensor 162 and, if necessary, to control the third sensor 162. In addition, the second zone control unit 160 is designed to control the second electrical control unit 164 or to receive and forward its data. According to this example, a fourth sensor 172 and a fourth actuator 174 are assigned to the eighth zone control unit 170. The eighth zone control unit is designed to control the fourth sensor 172 or to receive, process and forward its sensor data. The eighth zone control unit 170 is additionally designed to control the fourth actuator 174 or to implement its control.

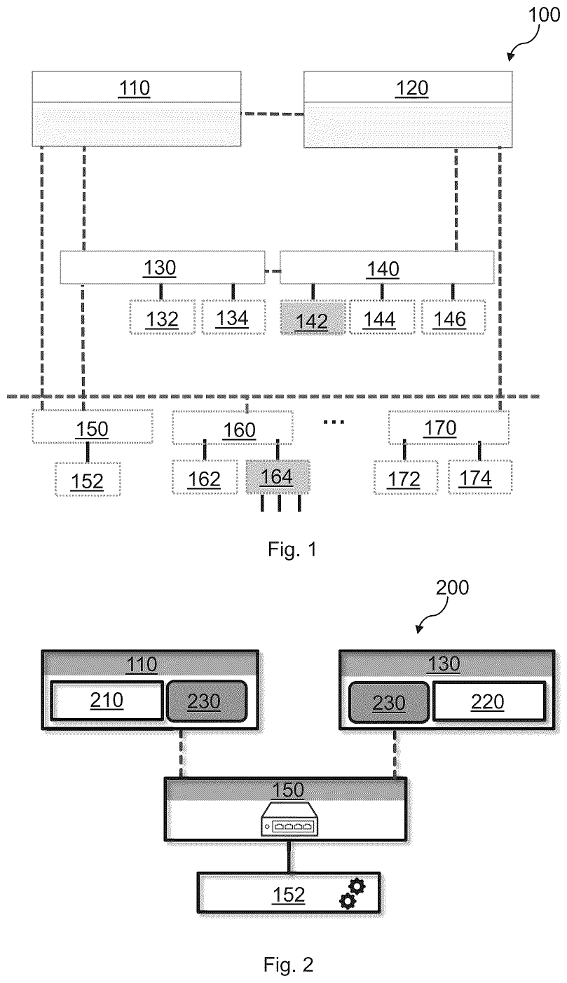

FIG. 2 shows an E-E/Hardware architecture detail 200 of the automotive system 100 of FIG. 1. The first vehicle server 110, the first master controller 130, the first zone control unit 150 and the third actuator 152 are shown. As can be seen from FIG. 2, the first vehicle server 110 is designed to control the third actuator 152 via the first zone controller 150. As a backup, the first master controller 130 is designed to control the third actuator 152 via the first zone control unit 150. The first vehicle server 110 has a primary software cluster 210 for controlling the actuator 152. The first master controller 130 has a backup software cluster 220 for controlling the actuator 152 when the primary software cluster 210 cannot be used to control the third actuator 152. Both the first vehicle server 110 and the first master controller 130 have a Fail OP Agent 230. The Fail OP Agent 230 (Fail Operational Agent) takes care of all the tasks required to restore the system, for example the monitoring, fail silent and starting of the backup software cluster.

The Fail OP Agent 230 allows all tasks required for the system restore process to be collected in one software component. The actual functionality (primary and backup software clusters) can also be executed independently of the Fail OP Agent 230, according to one example.

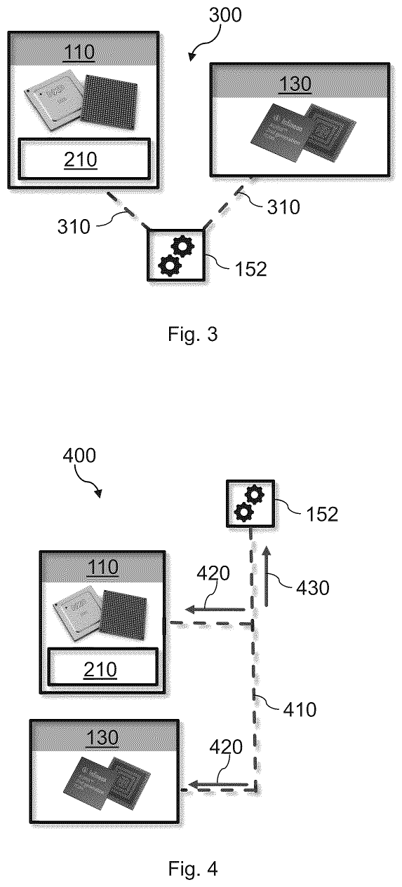

FIG. 3 shows a first network configuration 300 between the first vehicle server 110, the first master controller 130, and the third actuator 152. The different components are connected to one another by an Ethernet or CAN connection 310.

FIG. 4 shows a second network configuration 400 between the first vehicle server 110, the first master controller 130, and the third actuator 152. The connection between the individual components according to the second network configuration 400 is implemented by a CAN or LIN connection 410. FIG. 4 also schematically shows input data 420 which is sent from the third actuator 152 to the first vehicle server 110 and/or to the first master controller 130. In both FIG. 3 and FIG. 4, the primary software cluster of the first vehicle server 110 is illustrated schematically. FIG. 4 also shows schematically a PWM signal 430, which can be sent via a CAN connection from the first vehicle server 110 or from the first master controller 130 to the third actuator 152. The network configuration 400 or the network configuration 300 can be used according to the method of the present disclosure for controlling the unit to be controlled. The method according to the present disclosure can therefore be used flexibly on different architectures. This allows cost advantages to be realized, as CAN or LIN architectures are less expensive than ETH architectures. In addition, ETH is a relatively complex protocol, which requires comparatively powerful computer hardware. CAN or LIN architectures can be implemented with low-cost hardware.

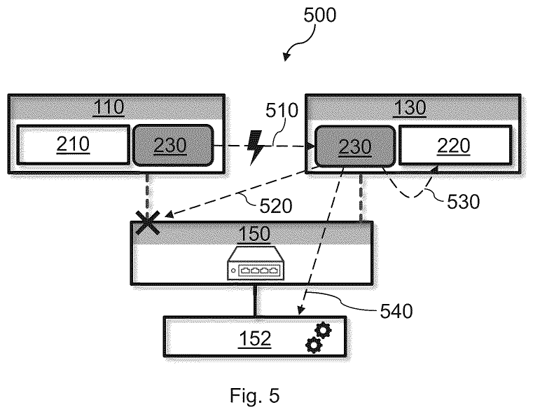

FIG. 5 corresponds in its schematic structure to FIG. 2, however, FIG. 5 additionally shows a flow diagram 500 of the method according to the present disclosure. In a first step 510, the first master controller 130 detects that the first vehicle server 110 is performing its tasks for controlling the third actuator 152 incorrectly or improperly. In some examples, a simple type of monitoring can be implemented by a so-called heartbeat signal, which the first vehicle server 110 sends cyclically to the first master controller 130. By the absence of the heartbeat signal, the first master controller 130 detects a malfunction of the vehicle server 110.

By way of the second step 520, as schematically illustrated in the flow diagram 500, the first master controller 130 ensures that the first vehicle server 110 switches to a fail-silent mode and accordingly behaves in a fail silent manner and no longer sends potentially erroneous data. For this purpose, the first master controller 130 additionally instructs the first zone control unit 150 to filter out and not to forward any data packets sent from the first vehicle server 110, thereby preventing the control of the third actuator 152 by the faulty first vehicle server 110 or by the faulty primary software cluster 210.

In a third step 530 of the flow diagram 500, it is schematically shown that the first master controller 130 continues to perform the critical functionality of the third actuator 152. For this purpose, the backup software cluster 220 of the first master controller is transferred from a so-called Hot Standby status to an active mode. This means that the backup software cluster 220 of the first master controller 130 is continuously executed and accordingly receives the same input values as the primary software cluster 210 of the first vehicle server 110. It is only the output of the backup software cluster 210 that is not forwarded to the third actuator 152 when there is no error present. In order to continue the safety-critical function by the first master controller 130, it is sufficient to activate the output of the backup software cluster 220.

In a fourth step 540, the flow diagram 500 schematically shows that the third actuator must also receive the output of the backup software cluster 220. For this purpose, it is necessary that the backup software cluster 220 connects master controller 130 to the first zone control unit 150 by Service Discovery, so that the backup cluster can control the actuator 152 via the master controller. The Service Discovery process reconfigures the system such that the third actuator 152 can exchange data with the backup software cluster 220 of the first master controller 130. If the Service Discovery is successful, the function of the third actuator 152 is restored by the backup software cluster 220 on the first master controller 130 and the automotive system 100 functions correctly again.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for controlling a unit of an automotive system, an electrical/electronic architecture of the automotive system comprises a first control unit, a second control unit, and the unit to be controlled, the second control unit is designed to control the unit by a primary software cluster and the first control unit is designed to assume control of the unit by a backup software cluster in the event of a fault of the second control unit, the method comprising:
detecting that the control of the unit by the primary software cluster is faulty and/or defective;
activating the second control unit by the first control unit, whereby the second control unit is transferred to a fail-silent state and does not send any more potentially erroneous data; and
controlling the unit by the backup software cluster of the first control unit, thereby maintaining a functionality of the unit.

2. The computer-implemented method of claim 1, wherein the electrical/electronic architecture of the automotive system also comprises a third control unit designed to receive control commands for controlling the unit from the first control unit or the second control unit, and wherein the control of the unit is carried out via the third control unit.

3. The computer-implemented method of claim 2, wherein the first control unit is a master controller, the second control unit is a vehicle server and/or the third control unit is a zone control unit.

4. The computer-implemented method of claim 3, wherein the unit to be controlled or the third control unit is activated by the first control unit to filter out and not to forward any data packets received from the second control unit, as soon as it is detected that the control of the unit by the second control unit is faulty or defective.

5. The computer-implemented method of claim 1, wherein the first control unit comprises a microcontroller and wherein the second control unit comprises a microprocessor.

6. The computer-implemented method of claim 1, wherein a heartbeat signal is sent from the second control unit to the first control unit continuously or cyclically and the first control unit detects that the control of the unit by the second control unit is faulty or defective if the heartbeat signal is absent or faulty.

7. The computer-implemented method of claim 1, wherein the unit is connected to the first control unit by a Service Discovery, as soon as it is detected that the control of the unit by the second control unit is faulty or defective.

8. The computer-implemented method of claim 1, wherein the activation of the second control unit by the first control unit to transfer the second control unit into the fail-silent state is carried out by a packet filter.

9. The computer-implemented method of claim 1, wherein the unit to be controlled is an actuator, a sensor to be monitored or another unit to be controlled of an automotive system or a combination of these.

10. The computer-implemented method of claim 1, wherein the automotive system additionally comprises a monitoring unit designed to monitor whether the unit to be controlled is properly controlled by the backup software cluster of the first control unit.

11. A system for controlling a unit of an automotive system, the system comprises:
the unit;
a first control unit executing a backup software cluster; and
a second control unit executing a primary software cluster to control the unit;
wherein
the first control unit assumes control of the unit by the backup software cluster in the event of a fault of the second control unit;
the first control unit activates the second control unit, whereby the second control unit is transferred to a fail-silent state and does not send any more potentially erroneous data; and
the first control unit controlling the unit by the backup software cluster causing the unit to maintain its functionality.

12. The system of claim 11, further comprising:
a third control unit designed to receive control commands for controlling the unit from the first control unit or the second control unit, and wherein the third control unit controls the unit.

13. The system of claim 12, wherein the first control unit is a master controller, the second control unit is a vehicle server and/or the third control unit is a zone control unit.

14. The system of claim 13, wherein the first control unit activates the unit to be controlled or the third control unit to filter out and not to forward any data packets received from the second control unit, as soon as the first control unit detects that the control of the unit by the second control unit is faulty or defective.

15. The system of claim 11, wherein the first control unit comprises a microcontroller and wherein the second control unit comprises a microprocessor.

16. The system of claim 11,
wherein the second control unit sends a heartbeat signal to the first control unit continuously or cyclically; and
wherein the first control unit detects that the control of the unit by the second control unit is faulty or defective when the heartbeat signal is absent or faulty.

17. The system of claim 11, wherein the unit is connected to the first control unit by a Service Discovery, as soon as the first control unit detects that the control of the unit by the second control unit is faulty or defective.

18. The system of claim 11, wherein the activation of the second control unit by the first control unit to transfer the second control unit into the fail-silent state is carried out by a packet filter.

19. The system of claim 11, wherein the unit is an actuator, a sensor to be monitored, or another unit to be controlled of an automotive system or a combination of these.

20. The system of claim 11, further comprising:
a monitoring unit designed to monitor whether the unit is properly controlled by the backup software cluster of the first control unit.
